(19) United States
(12) Patent Application Publication
(10) Pub. No.: US 2002/0180113 A1
(43) Pub. Date: Dec. 5, 2002

(54) Rotary-die-cutting machine

(76) Inventor: John Anthony Sullivan, Stockport Cheshire (GB)

Correspondence Address: Bracewell & Patterson, PO Box 61389, Houston, TX, 77208-1389, US

(21) Appl. No.: 10/148,249

(22) PCT Filed: Feb. 22, 2001
(86) PCT No.: PCT/GB01/00739

(30) Foreign Application Priority Data
Feb. 25, 2000 (GB) 0004345.5

(51) Int. Cl. B26D 3/00; H05B 7/00

(52) U.S. Cl. 264/484; 83/55; 83/40

(57) ABSTRACT

A rotary die-cutting machine and a method of cutting die-blanks in which the blanks (B) are passed between a die-cylinder (10) and an anvil (12), wherein a static charge is developed on the anvil (12) so that trim (15) removed from the blank adheres to, and is carried away from the nip, by the anvil (12).

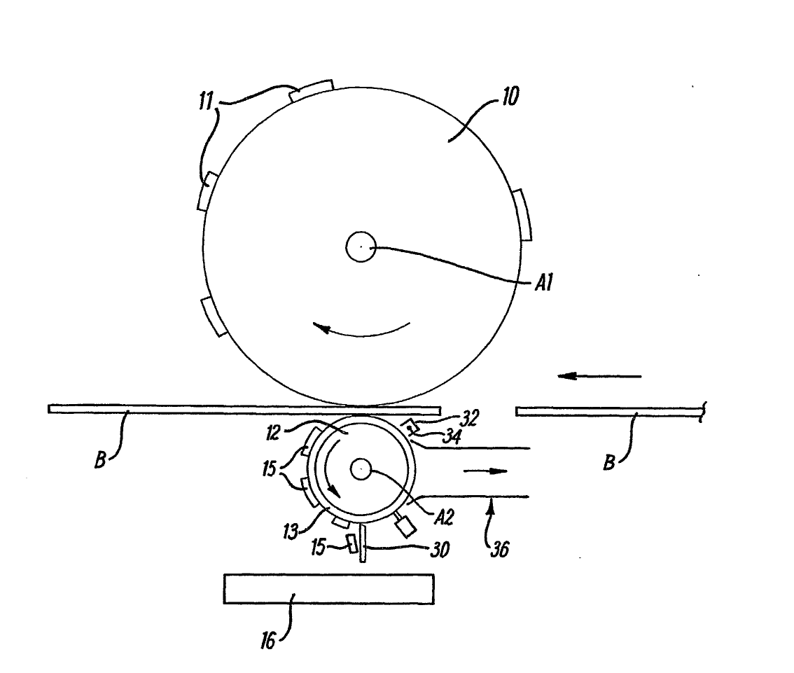

This invention concerns a rotary die-cutting machine of the kind (hereinafter termed of the kind referred to) wherein a stream of successive blanks of for example corrugated paper board are fed between a rotating die-cylinder and a rotating cylindrical anvil.

A major problem in the industry is separating the cut trim from the blanks after the die-cutting operation. All manner of different mechanical solutions have been attempted but such are not always wholly successful, and it should be understood that if any unwanted trim material finds its way into a completed box, that box is likely to be rejected, particularly if intended for food packaging.

According to the present invention there is provided a rotary die-cutting machine of the kind referred to which is designed to encourage or develop the build-up of static charge on the anvil, whereby trim is drawn from the blanks being processed and carried away subsequently to fall or for removal from the anvil under the influence of gravity.

The generally perceived wisdom is to attempt to eliminate the build up of static charge on the anvil to prevent collection of dust which could otherwise be forced by the knives of the die- cylinder into cuts in the surface of the covering material on the anvil.

In contrast with perceived wisdom, the present invention involves the deliberate build up electrical charge on the anvil so that the trim can be drawn from the blanks for subsequent release from the surface of this anvil, e.g. under the influence of gravity or by scraping clean the anvil with mechanical means.

The anvil may have a' covering of polyurethane and be of different, e.g. smaller, diameter relative to that of the die-cylinder.

The anvil may be electrically isolated from ground.

The electrical charge may be developed on the anvil with the aid of an electrode located in the vicinity of the peripheral surface of the anvil, e.g. at a location in advance of the location at which the trim is cut loose and would otherwise fall away. Typically the electrical charge is developed on the anvil at or immediately upstream of the nip between the die-cylinder and the anvil.

Various other features and aspects of the invention will become apparent from the following description and the appended claims.

The invention will now be described by way of example only with reference to the single figure of the accompanying diagrammatic drawing which is a side elevation of one form of die-cutting machine in accordance with the invention.

Referring now to the drawing, it will be seen that the die-cutting machine comprises a die-cylinder 10 which is rotatable about axis A1 and mounts tools 11, e.g. cutting knives, and a cylindrical anvil 12 which is rotatable about axis A2. The anvil has an outer sleeve 13 of a suitable electrically insulating material, preferably a polyurethane material. In the illustrated embodiment, the cylinder 10 is of large diameter relative to that of the anvil 12 although this need not be the case for other embodiments of the invention. Typically the ratio of the two diameters might be 3:1.

The cylinder 10 and anvil 12 are driven in such a way that their peripheral speeds are substantially equal. Blanks B of corrugated paper board are stream fed through the nip between the cylinder 10 and anvil 12 whereby shaped portions are cut therefrom for removal from the location of the nip.

Because of the relatively small diameter of the anvil 12, the polyurethane sleeve 13 separates from the blanks B at high speed generating an electrostatic charge on the sleeve 13 which causes the shaped portions or trim 15 to adhere to the sleeve 13 and be drawn from the blanks B so that it can be carried downwardly to drop from the anvil under the influence of gravity at the bottom of the anvil 12 for collection and removal by a lateral conveyor 16, the direction of travel of which is generally parallel to the axes A1 and A2.

While the trim may detach from the anvil under the force of gravity, means may be provided for positively effecting removal of the trim from the anvil, e.g. a scraper blade 30. The arrangement is desirably such that, by virtue of the electrostatic charge produced on the anvil, the trim adheres to the anvil for at least 90° from the nip as considered in the direction of rotation. The scraper or the like 30 is typically located so as to co-operate with the anvil at a location below the horizontal plane passing through the axis A2, e.g. at a location which is about 180° past the nip.

As thus far described, the charge is developed on the anvil by virtue of the separation of the blanks B at high speed form the anvil. This charging mechanism can be enhanced electronically and controlled to direct the trim as described. Alternatively, the charge on the anvil may be developed primarily or wholly by a separate charging device to carry the trim away from the nip in the manner described. Such a device is depicted by reference numeral 32 in the drawing and comprises an electrode 34 in the form of a wire which is located adjacent the peripheral surface of the anvil and extends substantially parallel with the axis A2.

The use of such a ‘device’ allows controlled charging of the anvil independently of ambient factors such as relative humidity of the air and/or moisture content of the material forming the blanks B. The charge developed may be selectively varied according to requirements, e.g. so that the trim 15 adheres to the anvil sufficiently to ensure that it does not fall away from the anvil until it has travelled at least 90° past the nip position whereby the trim can be deposited in an orderly fashion on the conveyor 16 or other collection point beneath the anvil.

High voltage is applied to the electrode 34 so as develop charge on the anvil by a suitable mechanism such as inducing charge or by corona, the charge being developed at a location which is upstream of the nip, e.g. 270° or more past the nip (in the direction of rotation). The electrode 34 is mounted within a channel-shaped housing of the device 32 for safety reasons. Suitable charge generators which may be adapted for the purposes of the present invention are commercially available.

The anvil 12 is mounted in such a way that it is electrically isolated from earth whereby the static charge developed thereon is retained as required. To this end, the anvil may be driven by a non-conducting transmission such as a toothed belt and be mounted in a bearing arrangement which ensures electrical isolation from earth.

The deliberate development of charge on the anvil runs counter to accepted wisdom, according to which electrical charge on the anvil is highly undesirable because it tends to attract dust which could be pressed into the material of the sleeve 13 by the tooling carried by the die-cylinder, the consequent accumulation of dust leading to the need for frequent replacement of the sleeve 13. To counteract the dust problem therefore, provision may be made of dust-removal means such as a vacuum cleaning arrangement including ducting 36 having an outlet which overlies part of the periphery of the anvil. Additionally or alternatively, charge neutralising means such as an “earthing device”, e.g. a graphite brush 38, may be provided, e.g. in advance of the vacuum cleaning arrangement.

It will be appreciated that it is not intended to limit the invention to the above example only; many variations, such as might readily occur to one skilled in the art, being possible, without departing from the scope thereof.

1. A rotary die-cutting machine of the kind referred to which is designed to encourage or develop the build-up of static charge on the anvil, whereby trim is drawn from the blanks being processed and carried away subsequently to fall or for removal from the anvil.

2. A machine as claimed in claim 1 in which charging means separate from the anvil and the die-cylinder is arranged to create a static charge on the anvil.

3. A rotary die-cutting machine of the kind referred to provided with charging means for creating a static charge on the anvil.

4. A machine as claimed in any one of claims 1 to 3 in which the anvil has a covering of an electrically insulating material.

5. A machine as claimed in any one of claims 1 to 3 in which the anvil has a covering of polyurethane.

6. A machine as claimed in any one of the preceding claims in which the anvil is of small diameter relative to that of the die-cylinder.

7. A machine as claimed in any one of the preceding claims in which the anvil is electrically isolated from ground.

8. A machine as claimed in any one of the preceding claims, the charging means being located upstream of the nip between the die-cylinder and the anvil.

9. A machine as claimed in any of the preceding claims, the charging means being controllable so that the charge created on the anvil can be selectively varied.

10. A machine as claimed in any one of the preceding claims in which the charge is produced by induction.

11. A machine as claimed in any one of claims 1 to 10 in which the charge is produced by an electrical corona discharge.

12. A machine as claimed in any one of the preceding claims including means for neutralising the charge on the anvil.

13. A machine as claimed in claim 12 in which the charge neutralising means is located more than 90° past the nip between the anvil and die-cylinder (in the direction of rotation).

14. A machine as claimed in claim 13 in which the charge neutralising means is located more than 180° past the nip in the direction of rotation.

15. A machine as claimed in any one of the preceding claims in which the charging means is arranged to create charge on the anvil at a location which is more than 180° past the nip in the direction of rotation.

16. A machine as claimed in any one of the preceding claims including means for removing dust from the anvil.

17. A machine as claimed in claim 16 in which the dust-removing means operates by applying suction to the periphery of the anvil.

18. A machine as claimed in claim 16 or 17 in which the dust-removing means is located upstream of the charging means.

19. A machine as claimed in claim 16, 17 or 18 in which the dust-removing means is located downstream of the point at which die-cut blank material leaves the anvil and upstream of the location of the charging means.

20. A machine as claimed in any one of claims 16 to 19 when dependent on any one of claims 12 to 14 in which the dust-removing means is located between the charge neutralising means and the charging means.

21. A machine as claimed in any one of the preceding claims in which the charging means includes an electrode located in the vicinity of the periphery of the anvil.

22. A rotary die-cutting machine of the kind referred to, substantially as hereinbefore described with reference to, and as shown in, the accompanying drawing.

23. A method of die-cutting blanks in which the blanks are passed through the nip between a die-cylinder and an anvil, characterised in that a static charge is developed on the anvil so that trim removed from the blank adheres to, and is carried away from the nip, by the anvil.

24. A method as claimed in claim 23 in which the charge is created by means of an electrode located in the vicinity of the peripheral surface of the anvil.

25. A method as claimed in claim 23 or 24 including selectively varying the charge on the anvil.

26. A method as claimed in any one of claims 23 to 25 including neutralising charge carried on the anvil at a location upstream of means for producing charge on the anvil.

27. A method as claimed in any one of claims 23 to 26 including removing dust from the anvil upstream of the nip.

28. A method as claimed in claim 27 in which dust-removal is effected at a location upstream of means for producing charge on the anvil.

29. A method as claimed in any one of claims 23 to 28 including collecting the trim on a conveyor located below the anvil.

30. A method of die-cutting blanks, substantially as hereinbefore described with reference to the accompanying drawing.

31. The use, in the die-cutting of blanks, of electrostatic charge to adhere the resulting trim to the anvil by electrostatic attraction to carry the trim away from the nip by the anvil.
